(19) United States
(12) Patent Application Publication
(10) Pub. No.: US 2026/0287870 A1
(43) Pub. Date: Sep. 24, 2026

(54) CONFOCAL MICROSCOPY APPARATUS

(71) Applicant: CRESTOPTICS S.P.A., Roma (RM) (IT)

(72) Inventors: Fabio NAZZARRI, Roma (RM) (IT); Emanuele ROCCIA, Roma (RM) (IT); Giampietro PISCOPO, Roma (RM) (IT); Raino CECCARELLI, Roma (RM) (IT)

(73) Assignee: CRESTOPTICS S.P.A., Roma (RM) (IT)

(21) Appl. No.: 19/474,513

(22) PCT Filed: May 23, 2024
(86) PCT No.: PCT/IB2024/055017

§ 371 Date: Oct. 10, 2025

(30) Foreign Application Priority Data
May 30, 2023 (IT) 102023000010944

(51) Int. Cl. G02B 21/00

(52) U.S. Cl. CPC G02B 21/0032; G02B 21/0044; G02B 21/0076

(57) ABSTRACT

A confocal microscopy apparatus is provided having a disk group with first and second rotating disks, to receive a structured light beam and to transmit a resulting excitation beam to an optics of a microscope focused on a plane of a sample, and an acquisition sensor which detects a fluorescent beam emitted by the plane of the sample. The disk group is optically interposed between the source and the plane of the sample. Movement means move the first and second rotating disks allow the resulting excitation beam implemented by the passage of the structured light beam through an opening of the overlapping of the holes. Each opening results from the overlapping of a first hole included in the first rotating disk and a second hole in the second rotating disk. The area of the openings is variable by adjusting the mutual positions of the first and second rotating disks.

### TECHNICAL FIELD OF THE INVENTION

The present invention relates to the fluorescence structured light microscopy technique, in particular confocal microscopy, and it relates to a confocal microscopy apparatus for acquiring and processing images. Such microscopy apparatus implements a multipoint scanner system with pinholes having rhomboidal shape with adaptive variable opening, compatible with different acquisition systems. The proposed apparatus allows to significantly increase the spatial resolution of the sample, by eliminating the halos due to diffused light from the out-of-focus planes of the sample itself.

### BACKGROUND

As it is known, the structured light microscopy techniques are based on the illumination of the sample which causes the fluorescence excitation not uniformly, but rather according to a well-defined arrangement or pattern, so as to obtain additional spatial information due to the interaction between the illumination pattern and the sample under examination. After having acquired one single interaction image (that is a sub-frame), this is stored and the illumination pattern is moved in a subsequent position. Then, one proceeds with acquiring a plurality of subsequent sub-frames, until the total covering of the sample, and then to the composition of the sub-frames in a final image of the plane under examination by using de-convolution algorithms which depend specifically on the used pattern type.

More in detail, the confocal techniques of known type are divided into two macro categories: with a point scanner, characterized by single pinhole with variable sizes, and with rotating disk (spinning disk), characterized by the presence of multiple pinholes with fixed size.

In the latter sector the rotating disk confocal microscope inserts, which consists of a disk with several pinholes (in Italian, literally, “pinholes”), which rotates at very high speed (about 5,000÷10,000 revolutions/min), therethrough the illumination which has to strike the sample is made to pass.

More generally, in optical field, the term pinhole relates to a very small and precise hole which is used as spatial filtering element. In detail, the pinhole is capable of generating a light spatial structure having as shape that of the pinhole itself. In terms of applications in microscopy field, the presence of one or more pinholes allows to remove the out-of-focus contributions and to obtain an image of the sample with greater detail.

The illumination is parallelized before meeting the rotating disk. The objective lens focuses multiple scanning points on the sample, in a certain area, by implementing a parallel illumination. At the frangent of one single complete rotation of the disk, each sample portion has been illuminated several times, by offering a frame rate—frequency of the frames, is the measure of how quickly a series of frames appears in one second, also designated with the acronyms fps, frames per second—typically equal to 1,000÷3,000 fps. The limitation, as in other scanning technologies, is given by the signal-noise ratio (spatial filtering of the out-of-focus contributions), even if one succeeds in reaching easily the video standard speed (~30 fps).

Even if one succeeds in obtaining a high frame rate by parallelizing the illumination (multi-spot concept), the rotating disks have one or two fixed sizes of pinhole which can intervene in the optical path, by reducing the field of view (FOV), that is the visual window or in other words the area captured by the camera which indeed is what is actually displayed.

The capability of spatially filtering the out-of-focus contributions by the apparatuses which implement the multipoint scanner technology depends upon the shape and size of the pinholes, the latter strictly functional with respect to:
used wavelength,
optics of the device linked to the confocal in particular microscope objective;
optics of the device or the devices connected to the device in which the multipoint scanner system is mounted.

The preceding factors join the resolution capability of the single points of the system for acquiring images considered as a whole (confocal apparatus and devices connected thereto), therefore such capability is not precisely controllable or predictable, by requiring a final adjustment of the chain or a portion thereof.

An alternative is represented by the solutions at a scanning point, that is by the laser scanning apparatuses which use one single pinhole, which then can be varied easily.

The variable pinhole allows to have an optimum resolution for each used objective; therefore, such solution is appreciated notwithstanding its lower speed than the spinning disk. The multiple pinholes of the spinning disk, on the other side, allow to have a very high acquisition speed and a wide field of view. These are essential features in microscopy, since they allow to obtain significant data more effectively.

The limitation of this technique, however, is linked to the fixed size of the pinhole, which not always guarantees an optimum resolution.

### SUMMARY OF THE INVENTION

The technical problem placed and solved by the present invention is then to provide a solution for reducing the time for acquiring the interaction images of the sample, while maintaining high resolution, allowing to obviate the drawbacks mentioned with reference to the known art.

Such problem is solved by a microscopy apparatus according to claim 1.

Preferred features of the present invention are set forth in the depending claims.

The present invention provides some important advantages. The proposed microscopy apparatus combines the two types of already known confocal solutions such as laser scanning and spinning disk, by joining the advantages obtainable by variable opening pinhole with the multi-pinhole technology of the spinning disk, by guaranteeing to be able to acquire quickly high significance image data.

According to a first advantageous aspect of the invention, the microscopy apparatus, the present invention relates to, then provides the use of a plurality of overlapped pinholes which implement passage lights of the illuminating beam having variable, or better adjustable, extension. The passage lights have a variable size depending upon the relative positioning of the overlapped pinholes of the respective disks.

Within the present invention, under passage light the minimum surface for the passage of the illumination which has to reach the sample is meant.

The proposed apparatus is particularly versatile since it has the capability of adapting to the noise compensation conditions required at the moment to cover a wide range of specifications, so as to allow the assembly thereof in different systems.

The apparatus uses at least two high-speed rotating disks, whereon a plurality of (for example photo-lithographed) openings or pinholes are obtained, arranged according to predetermined patterns. The patterns can follow an Archimedean spiral path; the pinholes can be configured as a continuous spiral slit. The geometry, the arrangement and the additional technical features of the pinholes and of the respective rotating disks, as well as the structure and the operating modes of the whole microscopy apparatus, are in accordance with what described in the European Patent Nr. EP3362836 B1, which is wholly incorporated in the present patent application. However, with respect to the technical solution of the just mentioned patent, the proposed apparatus differentiates especially since it comprises more than one rotating disk and it is configured in such a way that the shape of the passage lights therethrough the illumination, which has to reach the sample, passes is variable, since resulting from the partial overlapping of at least two pinholes with preferably polygonal geometry, each one carried on a respective rotating disk. Each pinhole pattern is obtained on a different disk, totaling at least two disks positioned along the optical trajectory followed by the light from the illumination source as far as the sample to be displayed.

According to a first preferred aspect, the pinholes present on each rotating disk have polygonal, in particular quadrangular and preferably rhomboidal geometry (FIGS. 1 and 2), but higher order polygonal geometries can be advantageously used, where under polygonal a broken line is meant, formed by the union of n not adjacent consecutive segments joining in an orderly manner n+1 points, two consecutive points thereof being never coincident. Alternatively, pinholes can be used having at least partially curved peripheral edges, for example having circular, oval, elliptical shape or having peripheral edges in which there is alternation between rectilinear portions and curved portions.

The rhomboidal shape for the at least two overlapped pinholes is preferred, considering that two rhombuses, if made to slide reciprocally with respect to each other, have an overlapped surface which in turn is a regular rhombus even if with different dimensions from the starting rhombuses, while keeping the symmetry along the two directions of the plane X-Y even after the opening adjustment (FIG. 3).

As said, the at least two rotating disks carrying the pinhole patterns are arranged facing each other, that is at least partially overlapped, along the trajectory travelled by the illumination from the source as far as the sample. According to an additional preferred aspect, the disks are arranged in sequence along such trajectory at a very reduced mutual distance, in the order of 0.10÷0.50 mm, defined to compensate implementation and operational mechanical uncertainties in use, such as for example planarity defects and/or associated vibration effects and adjustment of the apparatus after assembly and use.

According to an additional advantageous aspect, the presence of immersion oil (specific for the optical field and microscopy) is provided in the space between the at least two disks, to make the apparatus stronger in terms of optical performances and mechanical stability. The oil is transparent to the light and suitable to compensate the refractive index difference of the materials which the light beam crosses along its optical trajectory as far as the sample, such as for example the glass of the first disk, the layer of oil itself and the glass of the second disk (FIGS. 4a and 4b).

According to additional preferred aspects, in order to guarantee the correct maintaining of the shape resulting from the overlapping of the pinholes, the two disks are moved by one single motor, preferably a brushless motor, keyed on the first one of them. The motor is configured to drag, synchronously, the second disk, through different mechanical connections.

Several different configurations of the device were developed, depending upon the relative motion between the disks which one wants to obtain and the used different mechanical connections.

A first configuration of the invention allows the mutual motion of the disks according to a translation motion. Such translation can be implemented in particular as:
a linear displacement of the rotation axis of a disk with respect to the rotation axis of the at least other disk, therefore the two disks do not result to be coaxial, wherein the motion continuity between the two disks can be implemented by magnetic coupling, elastic coupling or Oldham coupling, respectively; or
a linear displacement for sliding a disk with respect to the other one (configurations shown in FIGS. 60a and 60b, wherein the internal white arrow represents the translation), with integral dragging of the second disk with respect to the first one and maintaining the coaxiality between the two disks, therefore the rotation axis is designated by the internal cross; such motion can be implemented by prismatic guides and axial conical pusher.

Alternatively, configurations—shown in FIGS. 59a and 59b—are proposed in which the relative angular displacement (represented by the internal white arrow) is implemented, along the circumference, between the disks which are coaxial, for example by an interposed conical pusher.

For each configuration, the relative displacement between the two disks implements a gradual increase or decrease in the opening resulting from the overlapping of the pinholes, which for example in preferred variants is adjustable between about 5 to 65 μm.

Preferably, a rotation speed of each disk of 10,000 RPM is obtained, which allows the apparatus to reconstruct with a higher speed than the acquisition one the entire image in the camera's FOV, while maintaining the cancellation properties of the out-of-focus contributions, instant by instant, during rotation.

Other advantages, features and use modes of the present invention will result evident from the following detailed description of some embodiments, shown by way of example and not for limiting purposes.

### BRIEF DESCRIPTION OF FIGURES

The Figures of the enclosed drawings will be referred to, wherein:

FIG. 1 shows a partial front view of the mask of a rotating disk of a preferred embodiment of an apparatus according to the present invention;

FIG. 2 shows an example of pinhole overlapping according to the present invention;

FIG. 2a shows a partial section view of a preferred embodiment of a rotating disk according to the present invention;

FIG. 3 shows an example of pinhole pattern according to the present invention;

FIGS. 4a and 4b shows a schematic course of the structured light refractive index in an apparatus according to the present invention;

FIGS. 5a to 6c show examples of pinhole overlapping according to the present invention;

FIG. 7 shows a partial section view of a preferred embodiment of an apparatus according to the present invention:

FIG. 8 shows the course of the average pressure of a fluid in rotation;

FIG. 9 shows a section view of a preferred embodiment of an apparatus according to the present invention;

FIG. 10 shows a section view of the sub-set of the first disk of a preferred embodiment of an apparatus according to the present invention;

FIG. 11 shows a section view of the sub-set of the second disk of a preferred embodiment of an apparatus according to the present invention

FIG. 12 shows a section view of the partial set of the two sub-sets of FIGS. 10 and 11;

FIG. 13 shows a section view of the complete set of the two sub-sets of FIGS. 10 and 11;

FIG. 14 shows a section view of the sub-set of the second disk of a preferred embodiment of an apparatus according to the present invention comprising a magnetic coupling;

FIG. 14b shows a section view of an apparatus according to the present invention comprising a magnetic coupling;

FIGS. 15 and 16 show respectively a section view of the sub-set of the second disk and of the sub-set of the first disk of an apparatus according to the present invention comprising a magnetic coupling;

FIG. 17 shows a section view of the sub-set of the first disk of a preferred embodiment of an apparatus according to the present invention comprising a magnetic coupling;

FIGS. 18 and 19 show respectively a section view of the sub-set of the second disk and of the sub-set of the first disk of an apparatus according to the present invention comprising an elastic coupling;

FIGS. 20 and 21 show respectively a section view of the sub-set of the second disk and of the sub-set of the first disk of an apparatus according to the present invention comprising an Oldham coupling;
the sequences of FIGS. 22a-22c and 23a-23c show schematically the relative translation and rotation between the disks implementable by means of Oldham coupling;
the sequences of FIGS. 24a and 24b show schematically the sliding of the apparatus in its entirety;

FIGS. 25 and 28 show a section view of a preferred embodiment of an apparatus according to the present invention;

FIGS. 26 and 27 show respectively details of the apparatus of FIG. 25;

FIGS. 29 to 36 show respectively details of the apparatus of FIG. 25, in assembly configuration;

FIG. 37 shows schematically the opening resulting from the configurations with relative linear displacement of the rotation axis of the disks,

FIG. 38 shows schematically a configuration of relative linear displacement of the disks while maintaining coaxiality;

FIGS. 39-41 show each a detail of the mechanisms for the sliding related to the motion of the balancing mass;

FIGS. 42-44 show, each one, a detail of the mechanisms for the sliding related to the motion of the flanges supporting the second disk; and

FIGS. 45-47 show respectively a left side view, a 60° cross section and a 90° cross section of a preferred embodiment of an apparatus according to the present invention.

FIGS. 48 and 49 show respectively a top and side section view of a preferred embodiment of an apparatus for which no protection is requested;

FIGS. 50 and 51 show each a construction detail of the configuration of FIGS. 48-49;

FIGS. 52 and 53 show respectively the relationship between the rotation of the first disk (lower disk) and of the second disk (upper disk) for the embodiment of FIGS. 48-49;

FIG. 54 shows schematically a comparison sequence between the rotation of the first disk and of the second disk, for the embodiment of FIGS. 48-49;

FIGS. 55 e 56 show respectively details of a top view of an additional preferred embodiment of an apparatus therefor no protection is requested;

FIG. 57 shows an example of pinhole sizing;

FIG. 58 shows a representative scheme of a preferred embodiment of a microscopy apparatus according to the present invention;
the sequence of FIGS. 59a and 59b shows schematically a configuration wherein the first disk and the second disk are coaxial and have an angular displacement; and
the sequence of FIGS. 60a and 60b shows schematically a configuration wherein the first disk and the second disk are coaxial and have a sliding linear displacement, with integral dragging of the second disk with respect to the first one.

The thicknesses and the curves represented in the above-mentioned Figures are to be meant as purely exemplifying, are generally magnified and not necessarily shown in proportion.

### DETAILED DESCRIPTION OF PREFERRED EMBODIMENTS

Various embodiments and variants of the invention will be described hereinafter and this with reference to the above-mentioned Figures.

Analogous components are designated in the different Figures with the same numeral reference.

In the following detailed description, the described different embodiments and variants are likely to be used in combination, where compatible.

For the technical information not described hereinafter, which are outside the focus of the present patent application, reference is made to the European Patent Nr. EP3362836 B1, which is wholly incorporated in the present patent application.

With reference to the scheme of FIG. 58, a confocal microscopy apparatus with several rotating disks according to the present invention designated with numeral reference 1000 first of all includes a source S of structured light, configured to be illuminated by a basic light beam and to generate a beam of structured light focalized on a first plane.

The apparatus comprises a disk group which includes at least a first rotating disk 5 and a second rotating disk 10, configured to receive the beam of structured light and to transmit a resulting excitation beam to an optics of a microscope M focused on a plane of a sample C the images thereof have to be acquired. The disk group is optically interposed between the source S and the plane of the sample C. A plurality of lenses L, a mirror Sp and a dichroic mirror Sd can also be present, arranged along the optical path which develops from the source S as far as the sample C, and then proceeds towards the image acquisition means or optical sensors 117, to direct and treat suitably the light radiation, according to already known techniques.

As shown in FIG. 2A, each one between the first rotating disk and the second rotating disk comprises, respectively, a disk-shaped substrate 115 composed of an optically transparent material and comprising a first planar surface 115a and a second planar surface 115b, respectively opposite, and a mask 116 arranged on one between the first surface and the second surface, comprising at least one sector provided with one or more holes PH, or pinholes.

The apparatus comprises movement means configured to move the first rotating disk and the second rotating disk in such a way that the resulting excitation beam is implemented by the passage of the structured light beam through at least one opening resulting from the overlapping of the pinholes, as shown in detail 1005 of FIG. 58, wherein each opening is resulting from the overlapping of a respective first hole included in the first rotating disk and of a respective second hole included in the second rotating disk. The area of the openings is variable by adjusting the mutual position of the first rotating disk and second rotating disk, according to modes which will be described in more details hereinafter.

The movement means substantially comprises a motor preferably configured to be integrally coupled with the first rotating disk and motion transmission means preferably configured to kinematically couple the motor with the second rotating disk.

A preferred configuration of the apparatus comprises movement means configured to move the first rotating disk and the second rotating disk according to a mutual translation motion. In particular, the apparatus comprises motion transmission means configured to perform a translation of the second disk with respect to the first one.

For example, the motion transmission means is configured to perform a linear displacement of the rotation axis of the second disk with respect to the rotation axis of the first disk, or still a sliding linear displacement of the second disk with respect to the first disk, wherein the rotation axes of each disk remain coincident.

Alternatively, variants of the apparatus are described—but not included within the protection—wherein the motion transmission means is configured to perform an angular displacement of the second disk with respect to the first disk, wherein the rotation axes of each disk remain coincident.

As said, each disk carries a respective substrate, disk-shaped too, which is made at least partially, preferably totally, of an optically transparent material, for example glass. Each substrate comprises a first planar surface and a second planar surface, opposite to the latter, apart from a mask applied or arranged integrally on one between such two planar surfaces. The mask has a disc-like shape too; the mask, the substrate and the disk can have all the same overall dimensions, in other words the main surface of each disk can coincide in extension with the surface of the respective substrate and with that of the respective mask. The at least two disks, in turn, can have the same overall dimensions of the main surfaces, which correspond to those of the respective circular faces.

Each mask has at least a sector provided with a plurality of through holes or openings (hereinafter more simply pinholes) arranged according to a predefined pattern. Such holes are optionally implemented by photolithography. Each mask with pattern, or an external surface thereof, consists or is wholly coated with material strongly opaque to the light, with light absorption rate preferably higher than 80%, for example highly black material opaque to the light.

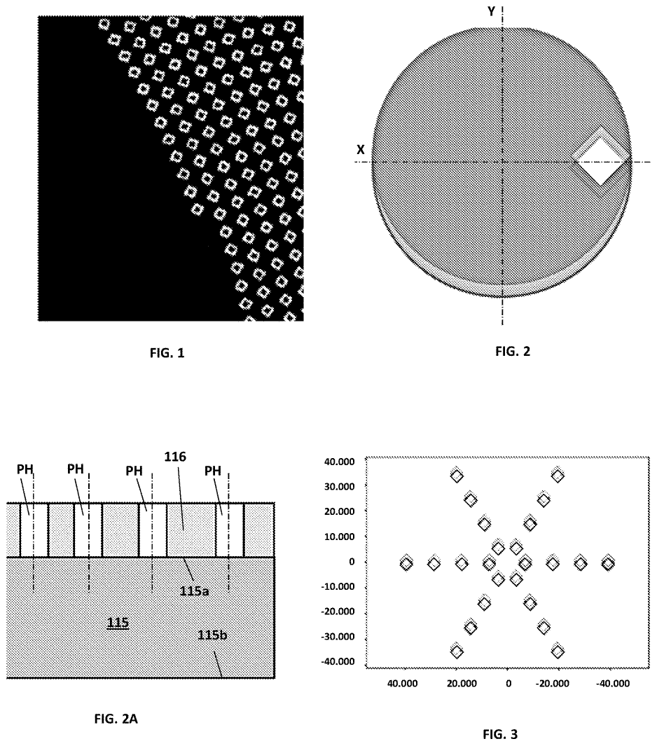

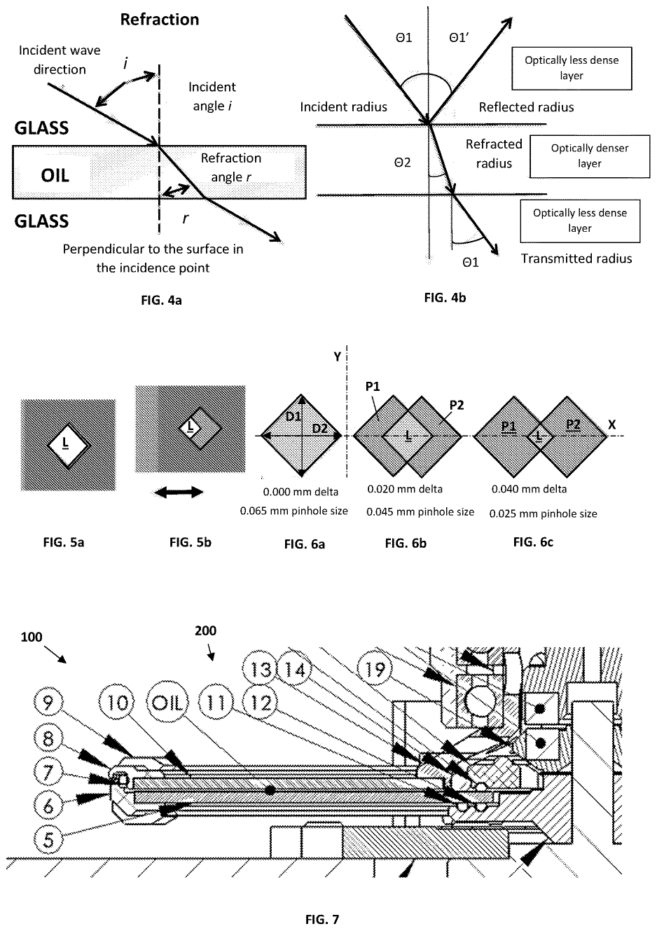

The pinholes are arranged on the respective disks according to patterns which follow a predefined path, for example an Archimedean spiral path (FIG. 1 and FIG. 58, where a trajectory example of the spiral path is highlighted with dashed lines and designated with the literal reference SA). The disks are arranged in such a way that the respective masks are at least partially overlapped along the optical trajectory followed by the structured light, by the source towards the sample (FIG. 2). The geometrical configuration and the pattern of the pinholes of the respective disks are such that the shape of the passage lights therethrough the illumination passes, resulting from the overlapping of the openings of pinholes overlapped along the optical trajectory followed by the structured light, is variable depending upon the mutual motion of the disks themselves, therefore the overlapping area between the pinholes is indeed variable, or better adjustable, over time and depending upon the specific application (FIG. 3).

The opening area or passage lumen for the illumination is determined by the at least partial overlapping of at least two pinholes carried on the different disks. In each case, it is always determined by the overlapping of the pinholes of all the disks arranged along the optical trajectory followed by the illumination towards the sample, condition required so that the light could pass beyond the disks and at last reach the sample.

The pinholes preferably have polygonal, in particular quadrangular, geometry, but polygonal geometries of greater order can be advantageously used, wherein under polygonal a broken line is meant, formed by the junction of n not adjacent consecutive segments joining in an ordered way n+1 points, two consecutive points of which are never coincident. According to preferred configurations, the pinholes can have different dimensions depending on whether they are included on the first disk or on the second disk and/or on the distance from rotation axis of the respective disk.

The rhomboidal shape is preferred upon considering that, for two rhomboidal pinholes which slide or rotate mutually with respect to each other (from a starting configuration in which such pinholes are perfectly overlapped), the surface of the opening resulting from their overlapping in turn is a regular rhombus, even if with different dimensions from the starting rhombuses. Moreover, such resulting rhomboidal opening preserves the symmetry along the two directions of the plane X-Y whereon the disks lie for any opening adjustment, that is for any mutual displacement of the pinholes, and then for any mutual displacement of the at least two disks.

As said, the at least two rotating disks are arranged facing one another, that is at least partially overlapped, along the optical trajectory of the structured illumination from the source as far as the sample, and preferably parallel to each other. Preferably, the disks are arranged in sequence along such trajectory at a very reduced mutual distance, for example comprised between about 0.00 and 0.50 mm. The disk group is configured optionally to provide a transmission oil-tight housing interposed between the first and the second rotating disk; more simply, the above-mentioned gap between the disks is wholly filled up with immersion oil.

Moreover, the apparatus comprises acquisition means—preferably an acquisition sensor—configured to detect a fluorescent beam emitted by the plane of the sample, as well as a set of lenses configured to conjugate optically the considered planes (there among the first plane, the plane of the disks and the plane of the sample).

Still, the apparatus includes optical means configured to transmit the structured light beam from the source to the plane of the sample and to transmit the fluorescent beam emitted by the plane of the sample to the acquisition means. Movement means can be provided configured to move the source of structured light, so as to move the structured light beam in the first plane and the rotating disks in a respective second plane.

The apparatus also comprises a central processing unit configured to receive from the acquisition means a plurality of partial acquisitions of the sample plane and to compose such plurality of partial acquisitions into a final image of the sample plane, by processing structured light microscopy de-convolution algorithms. The central processing unit can include one ore more graphic processors or GPUs.

The image acquisition and processing method in structured light confocal microscopy implementable by the herein described apparatus then provides, in summary, the following steps:
making the rotating disks to be crossed by a structured light beam, therefore the light beam passes through openings with variable size depending upon the related motion of the pinholes of the respective disks, by obtaining a resulting excitation light beam;
focalizing the resulting excitation beam on a sample plane, and
acquiring a plurality of partial acquisitions of the sample plane and composing such plurality of partial acquisition in an image of the sample plane by processing structured light microscopy de-convolution algorithms.

Hereinafter, preferred embodiments of the invention will be described, wherein the rotating disks are present in number of two by exclusively way of example and not for limitative purposes.

With reference to the sequence of FIGS. 6a-6c, the pinholes have preferably rhomboidal geometry, wherein D1 designates the rhombus diagonal arranged along the axis Y in a planar bidimensional reference system X-Y whereon the respective disk lies, and D2 designates the rhombus diagonal arranged, i.e., along the axis X, perpendicular to D1. By considering two pinholes P1, P2 of different rotating disks having same rhomboidal geometric configuration and same sizes and orientation on the plane X-Y (with diagonal D1 parallel to axis Y), it can be noted that by varying the mutual overlapping area of the pinholes by moving the above-mentioned disks, the illumination passage light L too has a variable extension. For example, starting from a complete overlapping configuration of the two pinholes wherein the passage light is a rhombus having size equal to that of the pinhole themselves, by means of a displacement A along the axis X the passage light remains rhomboidal, but it reduces its sizes, in order to adapt to different acquisition needs preferably in the range 5 μm 65 μm. The motion of the disks can be implemented both continuously and with discrete steps, with incremental width of the variation of the diagonal D2 of the passage light preferably equal to 5 μm. In other words, with mutual displacements Δ of the disks along the axis X, in sequence, each time equal to 5 μm.

In order to implement such relative displacements, and in particular with ranges of 5 μm, it is preferable using micro-positioning piezoelectric actuators having the following preferred features:
stroke comprised between about 100 and 200 μm;
stroke control type: closedloop, single axis;
scanning step frequency 40-50 μm;
repeatibility: 100 nm;
resolution: 100 nm;
weight to be moved: 100÷200 g, for a maximum displacement equal to 50 mm;
power supply/interface, analogue voltage only 0-10V, OEM.

The optimum shape of the pinholes which better guarantees the overlapping behaviour repeated for the whole spiral pattern, in particular in the passage area related to FOV of 25 mm, results to be the quadrangular one, preferably square and arranged with the diagonals respectively parallel to the axes X-Y, as shown in Figure Sa.

The two pinholes P1, P2 in the shape of quadrangular polygons, even if they move with respect to each other (FIG. 5b), guarantee to maintain the final shape of the passage light determined by their overlapping, a quadrangular polygon too, symmetric with respect to the axes X and Y of the plane of incidence, preferably with a tolerance of ±1 μm—so as to reduce the delta of approximation to the circle, which represents the ideal shape for the light passage related to the point scanner systems, as shown in the sequence of FIGS. 6a-6c.

According to preferred variants, the disks carry two sets consisting of mappings respectively of two spirals and five spirals, each one thereof with pitch equal to 250 μm and distance between one pinhole and the subsequent one on the specific spiral equal to 250 μm. The nominal FOV is preferably equal to 25 mm. By adopting as base structure the one of the spinning disk as described in the European Patent Nr. EP3362836 B1, and in a precautionary way by giving to the preferably brushless motor a diameter for example comprised between 28 mm and 30 mm, considering an uncertainty delta on the diameter of the possible coupling flanges up to 33.6 mm, it is preferable to generate the mapping of the pinholes with a starting diameter equal to 34.5 mm. The external diameter of end FOV in this case results to be equal to 84.5 mm. At last, the construction external diameter of the disks can be fixed in the range comprised between 88.5 and 92.5 mm, which optionally can be extended up to 100 mm.

As said, the compensation of the refractive index variation among the components of the kinematic chain in rotation is performed by immersion oil interposed between the rotating disks. The immersion oil is interposed between the two disks for optical reasons—harmonizing the refractive index variation that the beam encounters upon crossing the confocal module specifically air-glass-air-glass-air and mechanical reasons—improving the mutual sliding between the two disks, compensating possible planarity defects and manufacturing tolerances as well as limiting gap thickness variations between the two disks during assembly and operation itself, these latter ones better meant as adjustments.

With reference to FIG. 7, in which an embodiment of the apparatus 100 is partially represented in details, which comprises two rotating disks, the lower disk 5 (or first disk), the external sealing bottom 6 of the flange, an external sealing o-ring 7, an external sealing upper flange 8, an external retaining clip 9 (6×60°), an upper disk 10 (or second disk) and an internal sealing o-ring 14 are shown, as example of a preferred embodiment of a sealing locking system of the rotating disks, suitable to prevent oil from leaking from the air space between the two disks.

The configuration is such that the subject oil thickness is kept uniform and dynamically confined, by avoiding leakages and leaks. Therefore, a sealing circuit was obtained by:
positioning of the internal gasket 14;
positioning of the external gasket 7;
glueing sealingly the flange 6 to the lower disk 5;
glueing sealingly the flange 8 to the upper disk 10;
glueing sealingly the supporting flange 13 to the upper disk 10;
external squeezing of the disks through elastic clips 9 (there can be four or eight clips) to compensate the oil centrifugal force when the disks are rotating.

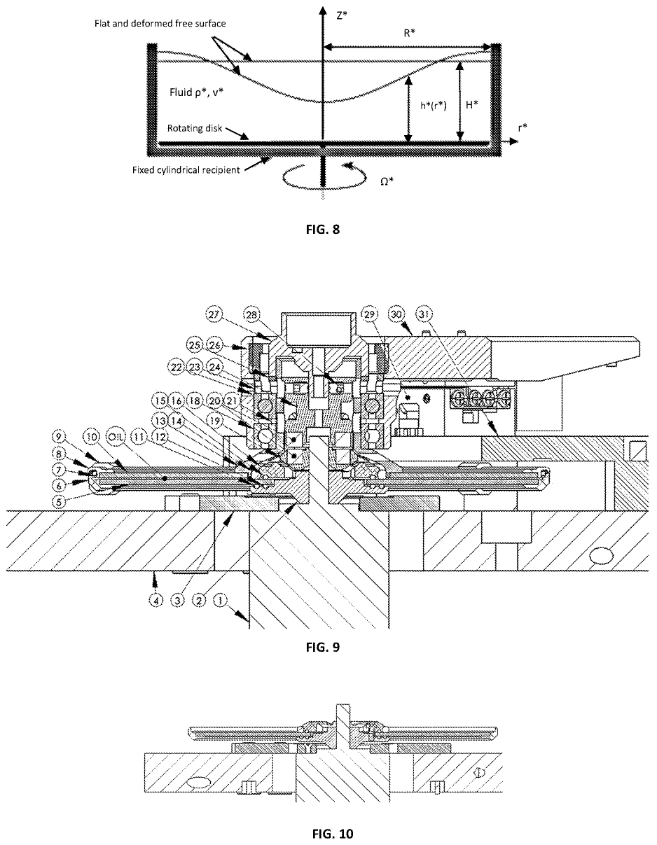

Note about the oil thickness, it is in the order of 0.30±0.20 mm and generates an average pressure given by the law (FIG. 8):

$$P = {{\int }_{r = 0}}^{r = R} ρ {ω}^{2} r dr = ρ {ω}^{2} {{\int }_{r = 0}}^{r = R} r dr$$

Where the integration extremes are respectively the internal and external radii of the housing of the oil itself, dosed per weight under standard conditions.

At a speed of the disks of 10,000 RPM, P=0.9 MPa=9 Kg/cm²=450 g of force per linear cm of edge sealing is obtained.

The components implementing the variable opening apparatus portion are placed in synchronous rotation, for rotation speed at steady state greater than or equal to 10,000 RPM. The preferred external sizes of the proposed apparatus are listed hereinafter: Height×Width×Depth=160×110×41 mm, that is:
Height: 80÷250 mm;
Width: 60÷170 mm;
Depth: 20÷70 mm.

Once established a speed level of the point scanner system, with rotation speed of the disks at steady state greater than or equal to 10,000 RPM, brushless motors are preferred which can guarantee ease in driving, moving torque capable of overcoming both the frictions among the components and the polar inertia of the same, and at last reduced sizes in terms of diameter and length along the rotation axis. A solution for the motor is the following:
Type: d.c. Brushless Motor
Electrical specifications: 24V, 30 W
Max. continuous torque: 37.3 mNm
Rotations at steady state: 15000 RPM

Hereinafter, embodiments exemplifying preferred configurations of the invention are described, which implement different modes of mutual displacement among the rotating disks.

### Relative Linear Displacement of the Rotation Axes of the Disks

The general configuration of the apparatus provides the linear displacement of the rotation axis of one disk with respect to the other one, with motion continuity guaranteed by a magnetic coupling, an elastic coupling or an Oldham coupling.

The Oldham coupling is a mechanical coupling which is useful to transmit the motion between two parallel shafts; in each time range, the angle by which the crankshaft has rotated is perfectly equal to the angle by which the driven shaft has rotated, therefore the speed ratio between the two shafts is constant and it is equal to one. The coupling mainly consists of a bearing element provided with two grooves (glyphs) with rectilinear axis and orthogonal to each other, to form a cross. On each one of the grooves a shoe is engaged, which is integral to one of the shafts. By rotating the crankshaft, by its ending shoe, the bearing cross is made to move, which, in turn, puts in motion the second shaft. The two shafts end with two disks in which two diametral grooves are implemented. The intermediate bearing body too has a disk-like shape and it is interposed between the two previous ones. As said previously, it has two orthogonal prismatic projections, engaging in the two grooves of the respective terminals.

The convenience in using this coupling is subordinated to the extreme proximity of the two shafts therebetween the transmission takes place: for high distances it produces considerable work losses due to friction and the yield is very low, but it results to be convenient in case the two shafts start from a position of perfect coaxiality and one of them is subjected to a displacement during operation.

The structure is common to all three configurations and, as to the operating mode, the two disks are considered as if they were wholly independent in their motion and in the anchoring points.

With reference to FIG. 9, a first embodiment of the invention is shown, with linear displacement of a rotation axis of one disk with respect to the other one, with motion continuity guaranteed by a magnetic coupling.

The assembly of such preferred variant is performed as follows. With reference to FIG. 10, which shows the assembly of the supporting components related to the lower disk (or first disk), the motor 1 is provided with interface flange 3; subsequently, the flange 2 is fixed by interference on the axis of the motor 1 which generates traction, whereas the lower disk 5 is rested upon the flange 2, in order to avoid the direct contact metal-glass by the elements 11 and 12. Previously, the containment external flange of the oil 6 was glued to the lower disk 5, whereas the flange 16 is positioned above the disk by interposing the element 15, then locking the whole with suitable screws, for example four screws M1.6.

The apparatus is balanced through correct centering positioning of the disk itself and made rigid by adding epoxy resin, the whole in order to make constant the behaviour under dynamic conditions. At the end of the assembly, the fixing to the frame 4 is implemented. The o-ring 14 for the oil circuit is positioned externally, first interface element between lower and upper system, and at last the altimetric measurement of the disc 5, useful to the subsequent assembly, is recorded.

Separately, the upper disk 10 (or second disk) is coupled to the supporting flange 13 (preferably by gluing on one of the two disks to reduce the gap therebetween) and, to the external edge of the disk itself, the oil containment flange 8 is coupled (glued), thereon the o-ring 7 is keyed, the latter to guarantee the oil external sealing. At last, the insertion of the bearing 18 and of the related spacer 21 is performed, to complete the first preassembled unit.

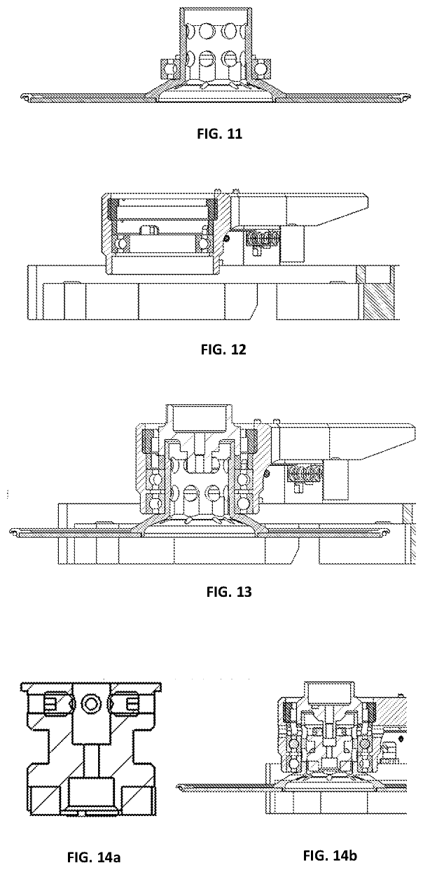

Then, separately, the assembly of the supporting components related to the upper disk follows, respectively the arm 30, the upper bearing 22 and the external spacer 23, by making to coincide the slits/cuts present on the spacer 23 with the holes on the external cylindrical edge of the arm 30, to fix the wished mechanical coupling to the axis of the system portion related to the upper disk, as shown in FIG. 11. Subsequently, the whole is tightened through the ferrule 26, the piezoelectric actuator 29 is fastened to the arm 30, and at last the support 31 is fastened to the piezoelectric actuator 29, to complete the second preassembled unit (FIG. 12).

The subsequent step, shown in FIG. 13, is to complete the assembly of the upper portion of the apparatus as follows, by inserting the two preceding preassembled units, positioning the internal spacer 25 with the same alignment caution of 23, and by tightening the whole with the ferrule 27. The tightening of the ferrule 27, in the configuration comprising a magnetic coupling, is preceded by the insertion, from top, of the magnets 20, of the second magnet disk flange 24 and of the grain for fixing the magnets 28 (FIGS. 14a-14b).

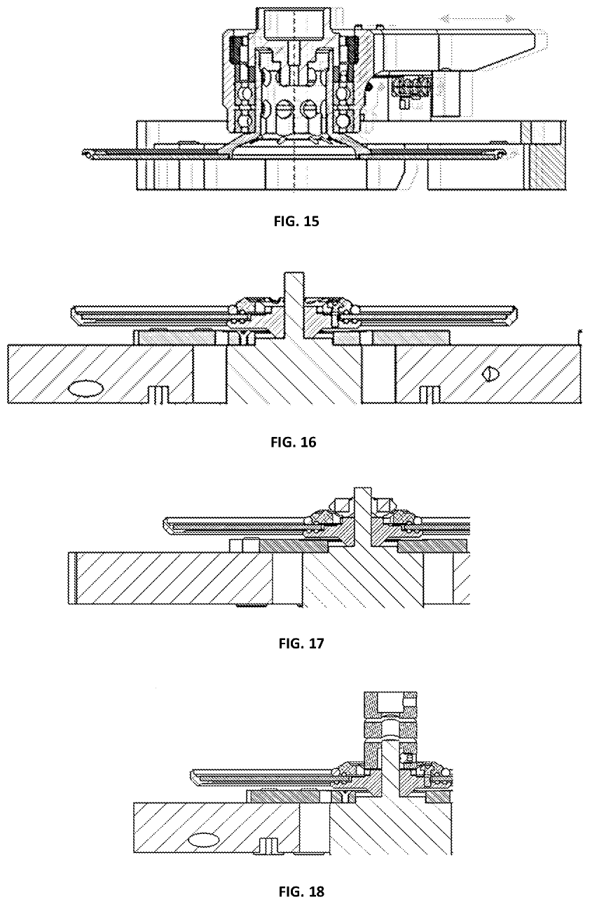

The upper system can rotate on its own axis (only if dragged, not being coupled to its own motor) but even translate laterally, along the axis of the piezoelectric actuator 29, as shown in FIGS. 15 and 16, which show the two aligned upper and lower sub-assemblies.

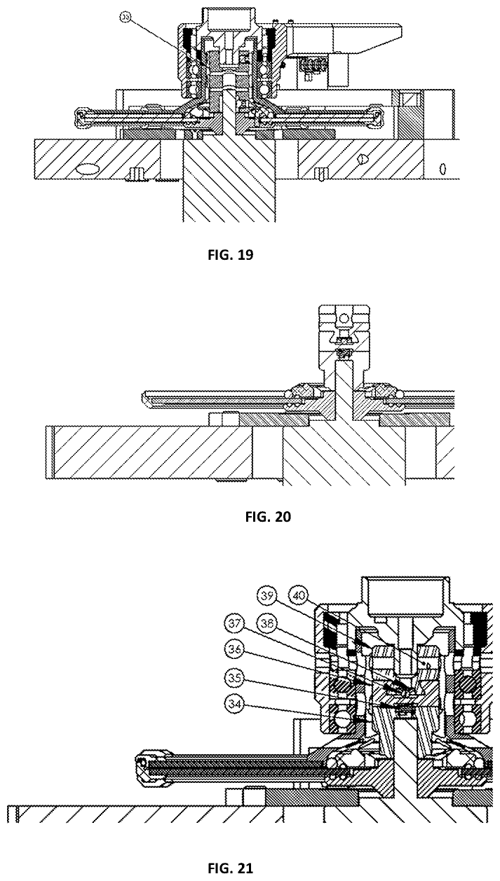

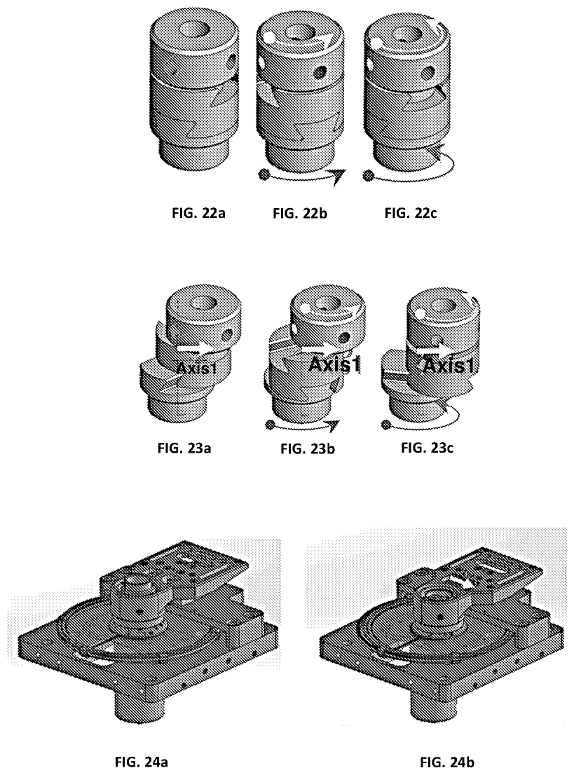

At last, the junction element is positioned on the base system by keeping accessible the fixing route, which element will respectively consist of:
for the magnetic coupling (FIG. 17): preassembled elements 19 and 20 keyed by interference on the motor axis, respecting a defined angular orientation; the magnets, like the upper sub-assembly, are assembled in even number and at alternated polarities, so as to exploit the attractive capabilities between upper magnet support and lower magnet support, as well as the repulsion between adjacent magnets on the same supporting flange—thus improving the auto-centering capability;
for the elastic coupling (FIGS. 18 and 19): the configuration is the same already described for the magnetic coupling, with motion continuity guaranteed by the single body of the elastic coupling 33, by tightening the related grain on the lower axis, by exploiting the aluminium flexibility in combination with the accordion geometry which increases the adaptability to the different positions of the axes—simple solution, but with vibrational margin.
for the Oldham coupling (better described hereinafter, shown in FIGS. 20 and 21): the preassembled series of the components designated with 34, 35, 36, 37, 38, 39 and 40 keyed by interference on the shaft; Belleville springs are preferable, since they allow to apply a higher preload in relation to their overall dimension, and the addition of the sphere allows to reduce the friction during the sliding phase between the components of the coupling and then between the disks themselves, then the springs allow to reduce the entity of the existing backlashes to very low values. The sequences of FIGS. 22a-c and 23a-c show schematically the relative translation and rotation implementable by such coupling.

Additionally, by referring again by way of example to FIG. 9, for the already illustrated configurations, once having completed the assembly of the respective coupling, the oil is deposited according to a dosage per weight until reaching an estimated amount to have a thickness of 0.20-0.30 mm on the upper surface of the disk 5, while taking care to position the disk in plane, so as to favour the oil spread at first by gravity, then by spatula in order to uniform the distribution thereof.

In this way, the apparatus is wholly assembled by exploiting the suitable seats provided in the couplings and in the axial interface elements of the two sub-assembled units, taking care in the correct positioning of the internal sealing 14 and external sealing 7 for the oil. It is possible to further compact the configuration by the radial insertion in the peripheral area of the disks of elastic clips, suitable to contain the centrifugal expansion of the upper 8 and lower 6 external flanges, as well as the centrifuge pressure of the oil put in rotation.

The choice of developing several connecting types arises from embracing different product ranges, in terms of global costs, overall dimensions and performances; thus each coupling covers different specifications in terms of speed, frictions and resistant torques, level of manufacturing complexity, possibility of tailor-made design, dynamic oscillation and dynamic offset. The sequence of FIGS. 24a and 24b shows, schematically, the sliding of the apparatus in its entirety, for a maximum stroke preferably equal to 150 μm.

Table 1 is reported below, summarizing the performances for each coupling configuration for the mutual linear displacement of the disks (V is the lowest rating, VVV the highest rating):

TABLE 1

| | Magnetic | Elastic | Oldham |
|---|---|---|---|
| Specifications | coupling | coupling | coupling |
| High speed | V | VV | VVV |
| Low friction | VVV | VV | V |
| Axial displacement | VV | V | VVV |
| Rotating mass entity | V | VV | VVV |
| Production cost | VV | VVV | V |
| Customizable sizes | VV | VV | VVV |
| Dynamic offset | VV | VV | VVV |
| setting | | | |

In conclusion, as it is clear from Table 1, the three coupling configurations result, each one, to be reliable for determined aspects. The simplicity of being able to pass from a configuration to the other one during the assembly of the apparatus allowed to develop a common production line for the most delicate components, and to reflect in dedicated lines the different features depending upon the coupling selected for the final configuration.

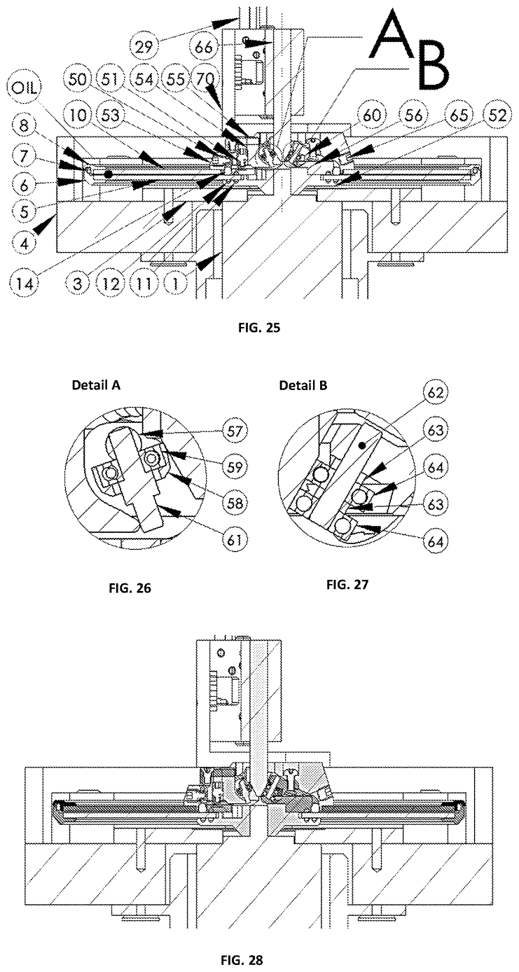

Relative linear displacement of the disks and maintenance of coaxiality Such configuration of the apparatus provides the linear displacement of the rotating disks with respect to each other, but keeping for both of them the same single rotation axis and guaranteeing the motion continuity between the two disks. As shown in FIG. 25 and more clearly in FIG. 28, a sliding linear displacement of the upper disk on the lower disk can be implemented by prismatic guides, with the motion actuated by a vertical conical pusher 66.

The prismatic guides preferably are localized on the elements 53 and 60 and allow the integral dragging of the second disk with respect to the first one, while maintaining one single rotation axis.

Within the present invention, under prismatic guide a set of geometrical profiles is meant suitable to create a constraint (called prismatic pair) allowing the translation of a body according to an assigned direction, by preventing the rotation and the displacement thereof in directions orthogonal to the one detected by the prismatic guide itself.

This solution advantageously allows to increase the specifications for keeping the variable shape of the pinholes with respect to the already described configurations, by reducing the relative motion parameters, with the introduction of a kinematically more complex system, but with only one degree of lability.

The mentioned embodiment is described hereinafter in greater details, still with specific reference to FIG. 25.

For convenience, the configuration is described by enucleating the differences with respect to the previously described configurations. The motor 1 is preferably provided with interface 3; the flange 52 is fastened by interference on the axis of the motor 1, which generates traction, whereas the lower disk 5 is rested upon the flange 52 therewith the direct contact metal-glass by the elements 11 and 12 is avoided. Previously, the oil containment external flange 6 was glued to the disk 5; the flange 56 is positioned above the disk 5 by interposing the element 15 and tightening the whole with suitable screws, for example four screws M1.6.

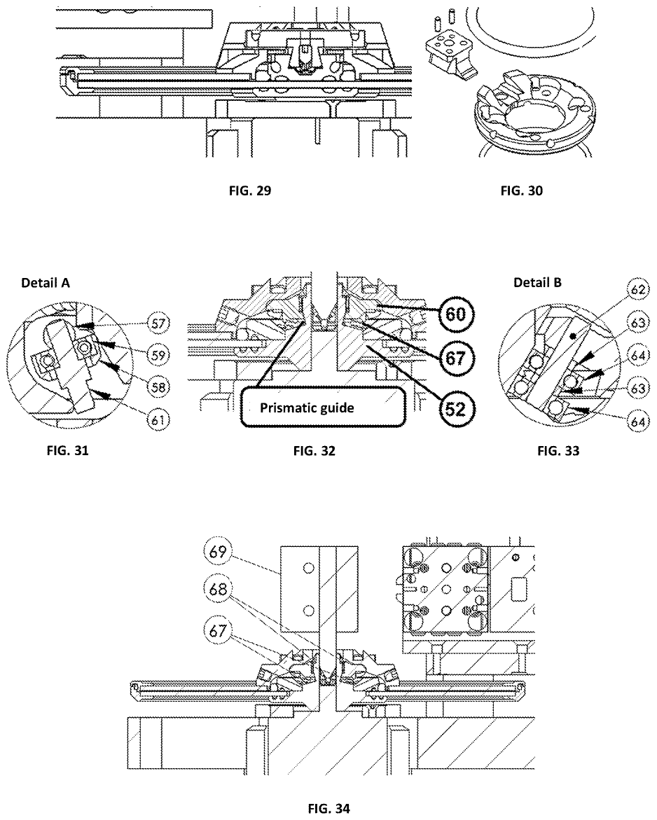

The apparatus will undergo balancing and gluing only at the end of the assembly, whereas, after these procedures, centering and planarization of the disk 5 are performed. The insertion of the mass 54 in the external prismatic guide implemented on 56 follows, by positioning it as externally as possible (FIGS. 29 and 30).

Separately, the upper disk 10 is glued to the supporting flange 53 and to the external edge of the disk itself, then the oil containment flange 8 is glued whereon the o-ring 7 is keyed, which implements the external sealing and completes the upper preassembled unit (FIGS. 31-33). On the flange 52 the elements shown in FIG. 26 are assembled, then oriented downwards.

Subsequently, the two pre-loading springs 67 of the second disk are positioned and at last in the second prismatic guide the supporting flange 60 is inserted thereto the elements of detail B mentioned above were pre-assembled. The so-assembled flange 60 then allows to anchor the sub-set of the previously pre-assembled second disk (that is the components designated as 10, 53, 8, 7).

The rotating an balancing components further comprise: an upper balancing mass 55, with related pins and screws, as well as pre-loading spring and grain 51 annulling the backlashes; pre-loading spring and grain 50 for the radial centering of the masses 54 and 55; preferably two pre-loading springs and grains 68 of the second disk.

Still, with reference to FIG. 34, separately the components of the piezoelectric actuator 29, the conical pin 66, the pin support 69, “L”-like arm 70 and support of the piezoelectric actuator 31 are assembled, which form the upper conical push, which indeed pushes on the internal displacement mechanism. Under conical pin a tapered cylindrical element is meant, with end tapered like a cone.

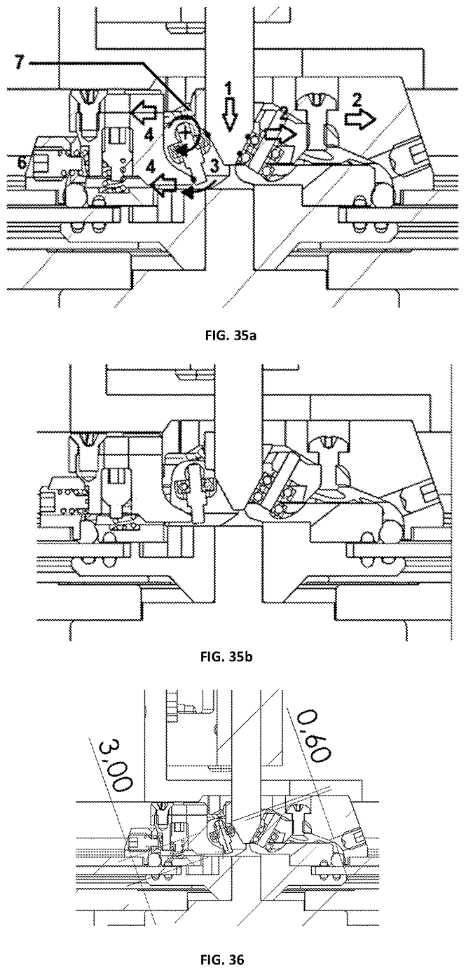

With reference to FIGS. 35a and 35b, the operating principle of the configuration comprising an external sliding coupling is schematically described hereinafter: the piezoelectric actuator 29, integral to the external frame through the components 31 and 70, moving vertically pushes the pin 66 integral thereto by pressing on the two sub-assemblies represented in FIG. 31 (it is integral to the lower disk 5) and 33 (it is integral to the upper disk 10). The pin 66, by lowering, moves the flange 53 and 60 and the disk 10 integral thereto towards right, by keeping the contact on two bearings shown in FIG. 33 (the contact points are represented on the right of the pin axis). The lower disk 5 remains on the initial axis not translating, but the system as a whole requires to have to balance (with respect to the rotation axis) the mass which has moved on the right. This takes place through the motion transmission from the pin 66 to the masses 54 and 55 on the left of the axis, whose displacement is shown with the horizontal arrows in FIG. 35a.

The pin 66 pushes on the rotating cam through the point contact shown in FIG. 31 at a distance δ_r_cam=K from the rotation centre of the mechanism of FIG. 31, designated with a cross. The masses 54 and 55 instead are in contact at a distance δ_r_mass=n*K from the rotation centre represented by the cross (n=amplification ratio of the displacement arm). An increased displacement results, due to the fact that the mass of the upper disk 10 and of the elements associated thereto is greater than the masses 54 and 55, therefore the latter have to move by a greater value to guarantee equilibrium (nominally null dynamic eccentricity) given by the formula:

$$esyst = 0 ; \to [ eleft = mleft * δ left ] = [ eright = mright * δ right ] mleft$$

$$mright = δ right δ left \to 4 gr 20 rg = 15 /= δ right n * δ right \to n = 5$$

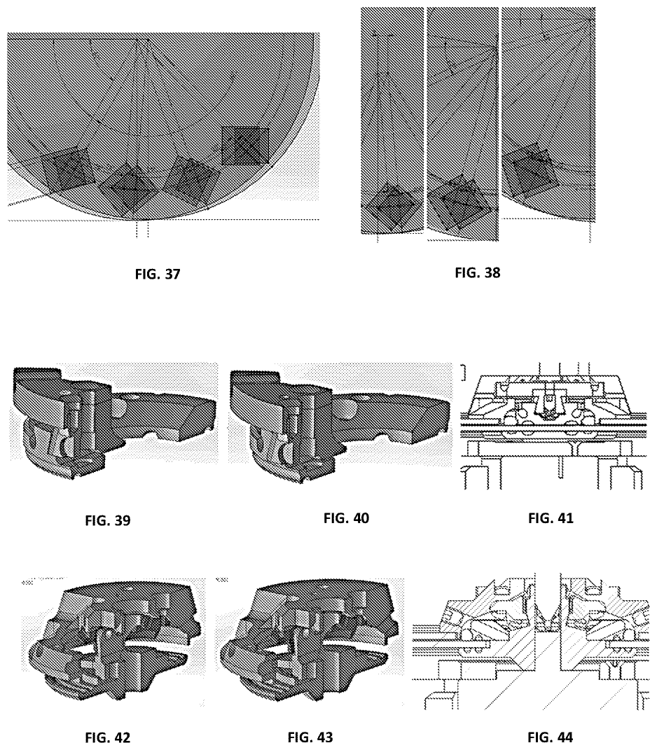

The detail of the contact distances between the cams is shown in FIG. 36. According to this mechanism, upon each radial displacement of the upper disk 10, wherein the disk rotates by changing its angular position but not the radial one, the second disk guarantees the wished opening of the pinholes constantly on all spirals, by respecting the equilibrium dynamic conditions of the masses (having moved masses proportionally different to inversely proportional displacements). With respect to the preceding ones, such configuration results to be mechanically more complex and delicate in the preloading adjustments, but much more stable in keeping the overlapped shapes, as shown in the comparison between FIG. 37, which shows the opening resulting from the configurations with relative linear displacement of the rotation axis of the disks, and FIG. 38, which relates to the configuration of the relative linear displacement of the disks with maintenance of coaxiality.

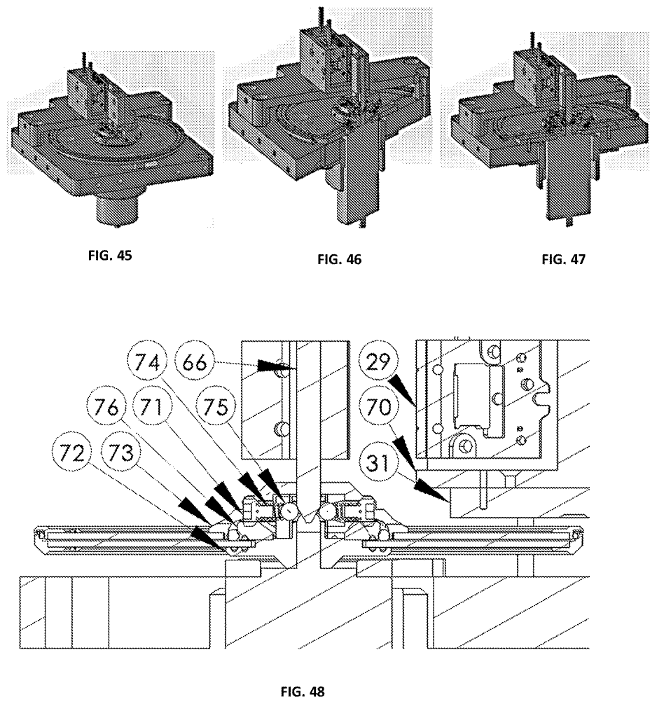

By way of example, FIGS. 39-41 show a detail of the mechanisms of the sliding related to the motion of the balancing mass, FIGS. 42-44 show a detail of the mechanisms of the sliding related to the motion of the flanges supporting the second disk, and FIGS. 45-47 show the wholly assembled apparatus, respectively a left lateral view, a cross section at 60° and a cross section at 90°.

### Relative Angular Displacement of the Two Disks and Maintenance of Coaxiality

An alternative configuration of the proposed apparatus is based upon the angular displacement of the disks, that is a mutual displacement along the circumference. According to such solution, the two disks are assembled coaxially with backlash in the order of few μm thanks to micromechanical precision machining, and moved by conical pusher as in the configuration just described above (linear displacement of the disks and maintenance of the same rotation axis).

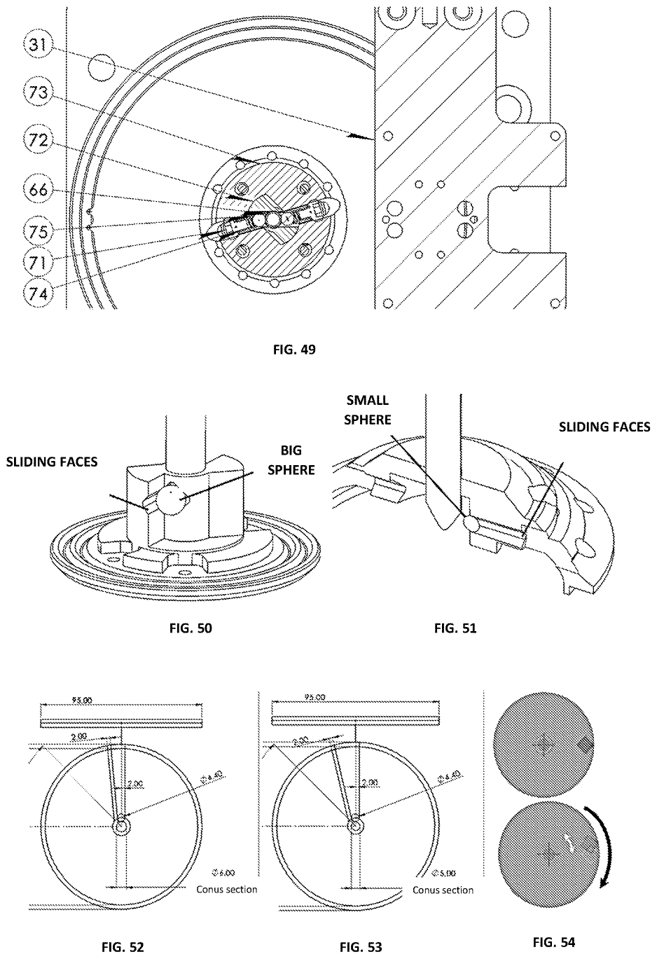

With reference to FIGS. 48 and 49, the pin 66 is moved by the piezoelectric actuator 29, the latter coupled to a fixed reference or frame through the components 31 and 70. The pin 66 pushes on the two spheres 75 arranged in axialsymmetric position and kept in preloading by the springs 74 with related grains 17. The flange 72 is integral to the lower disk 5, whereas the flange 73 is integral to the upper disk 10. The just mentioned flanges are assembled coaxially so as to be able to rotate mutually with respect to one another on one single axis; such motion, however, is constrained by the position of the spheres, which lie on channels consisting by half side of the geometry of the lower flange 72 and by the other half of the geometry of the upper flange 73, as shown in FIGS. 50 and 51.

The spheres are displaced radially due to the descent of the pin 66 and reduce the distance between the sliding faces signalled in FIGS. 50 and 51, thus defining a controlled relative rotation between the two flanges, both the latter ones dragged asynchronously by the motor 1 keyed on the lower flange 72.

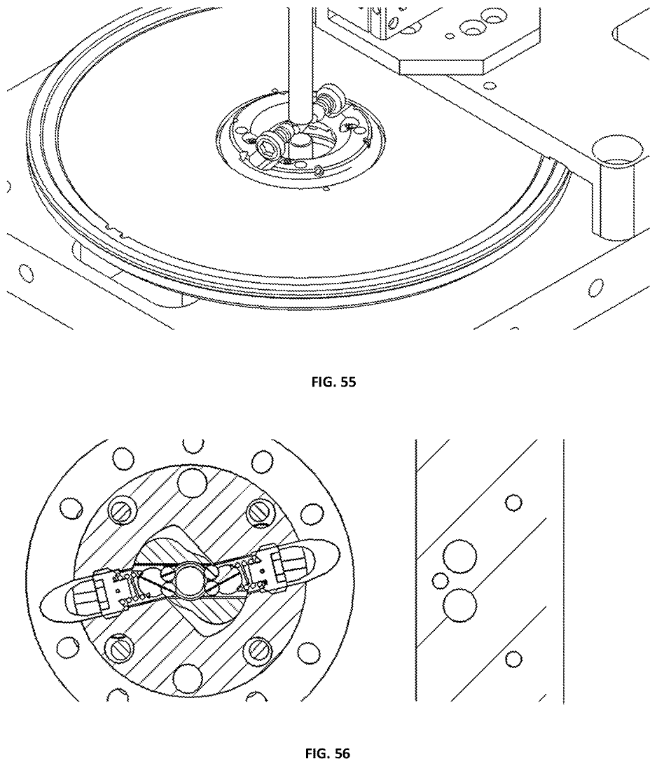

FIGS. 52 and 54 show respectively the relationship between the rotation of the first disk (lower disk) and of the second disk (upper disk), with relative comparison sequence represented in FIG. 55.

An additional configuration of the apparatus to implement the relative angular displacement of the two disks and to keep the coaxiality thereof by reaching greater speeds and reducing wear among the components is shown in FIGS. 55 and 56. The biggest spheres (or main spheres), previously in direct contact with the conical pin, are provided with two domed excavations, wherein two spheres per portion are housed, smaller—with reduced diameter—with respect to the main spheres. The last small spheres position between the big spheres and the pin. Therefore, the big spheres do not roll anymore on the faces of the prismatic guides but they are only dragged by the rotation of the whole system, by minimizing frictions and wear. The smaller spheres, made of suitable anti-wear material, instead, rotate with respect to the central pin and crawl on the external ones, by displacing the crawling indeed only between mutual spheres.

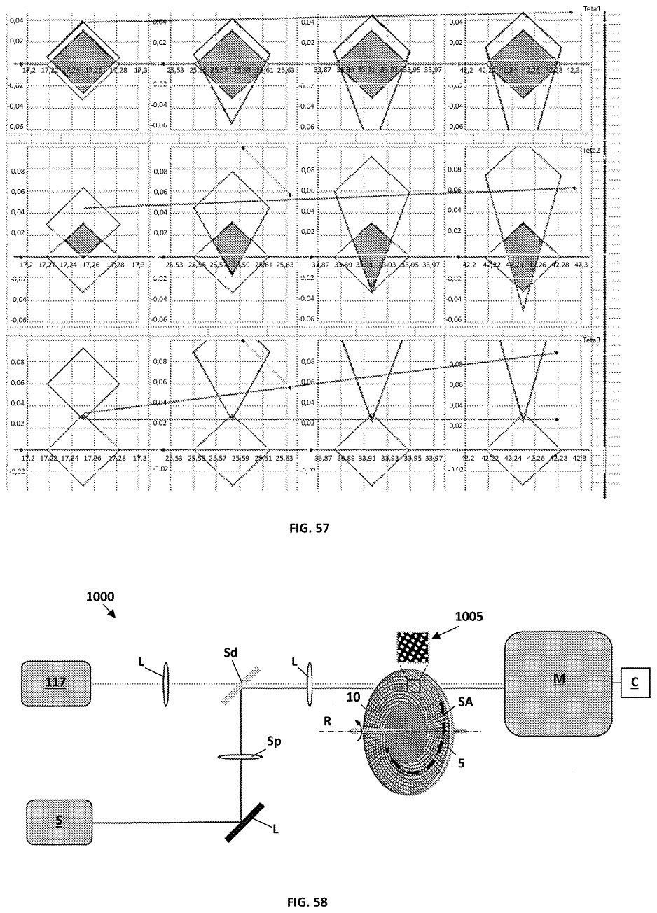

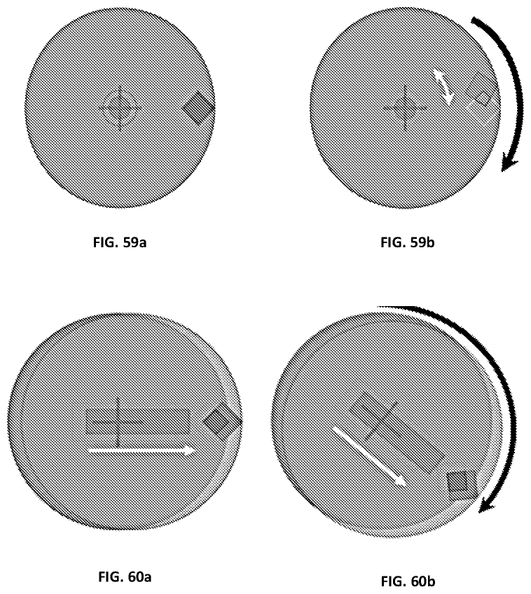

For such configuration, the sequence of the shape of the pinholes has to be adaptive to the radius, as it has to compensate the displacement on the circumference. The latter displacement, the related rotation being equal, results to be incremental with the distance from the centre, by covering different arches and respective different radii. The pinholes on the two disks result to have elongated, stretched and/or scaled shapes differently with respect to the mutual distance from the disk centre. Then, the sizes and the proportions of the pinholes for example are directly proportional to the distance from the rotation axis of the respective disk, and they can vary for the two disks. The lengthening of the pinholes is calculated specifically for each one of the two disks, with the purpose of obtaining an overlapping area with variation of ±10%. A sizing example in this sense is shown in FIG. 57. In this estimation, also the constructive factor of the lithographed shapes is computed, that is the the sharp edges in the reality are implemented even with radius bevels equal to about 1÷2 μm.

Such configuration conjugates the advantage of simplicity of the proposed kinematic chain, suitable to implement the variable opening resulting from the overlapping of the pinholes of the different disks, with technological refinement of micro-precision required to reduce the coaxial coupling backlashes. At last it results extremely advantageous to keep the equilibrium under dynamic condition (balancing), however requiring with respect to the preceding configurations a specific study of the shapes of the pinholes no more equal for each position, but variable from disk to disk and from radius to radius.

The present invention has been described so far with reference to preferred embodiments. It is to be meant that other embodiments belonging to the same inventive core may exist, as defined by the protective scope of the herebelow reported claims.

### Legend of Some Enclosed Figures

### FIG. 9:

1: brushless motor;
2: lower flange of the first disk;
3: motor support plate;
4: system-carrying frame;
11: external o-ring of the first lower disk;
12: internal o-ring of the first lower disk;
13: upper disk carrying second flange;
15: first external upper disk o-ring;
16: first upper flange of the disk;
18: lower arm bearing;
19: magnet disk first flange;
20: magnets;
21: intermediate spacer of the bearings of the internal arm;
22: bearing of the upper arm;
23: external upper spacer;
24: magnet disk second flange;
25: internal upper spacer;
26: external upper ferrule;
27: internal upper ferrule;
28: magnet fixing grain;
29: piezoelectric actuator;
30: piezoelectric arm;
31: support for sliding

### FIG. 21:

34: lower Oldham flange;
35: torsional preload spring
36: intermediate Oldham flange;
37: driving sphere;
38: Bellleville spring;
39: upper Oldham flange;
40: fixing grain.

### FIG. 25:

29: piezoelectric actuator,
50: grain of the horizontal preload flange,
51: mass grain of vertical preload,
52: lower flange of the first disk;
53: second upper disk-bearing flange;
54: lower balancing mass;
55: upper balancing mass;
56: first upper flange of the disk;
60: upper disk second intermediate flange;
66: vertical conical pin;
70: L-shaped arm.

### FIG. 26:

57: coupling cylinder;
58: cam flange;
59: cam bearing;

### FIG. 27:

62: pin contact pin;
63: contact spacer;
64: contact pin bearing.

### FIG. 32:

52: lower flange of the first disk;
60: upper disk second intermediate flange;
67: preload spring.

### FIG. 48:

29: piezoelectric actuator,
31: support for sliding
66: vertical conical pin;
70: “L”-shaped arm;
71: preload grain (2×);
72: first disk lower flange;
73: upper disk bearing second flange;
74: preload spring (2×);
75: contact sphere (2×).

1. A confocal microscopy apparatus, comprising:
a generation source of structured light;
a disk group comprising at least a first rotating disk and a second rotating disk, configured to receive said structured light beam and to transmit a resulting excitation beam to an optics of a microscope focused on a plane of a sample, said disk group being optically interposed between said source and the plane of the sample;
wherein said first rotating disk and second rotating disk respectively comprise:
a disk-shaped substrate composed of an optically transparent material and comprising a first planar surface and a second planar surface, respectively opposite, and a mask with pattern arranged on one of the first planar surface and the second planar surface, said mask comprising at least one sector provided with one or more holes, wherein the mask with pattern or an external surface thereof is composed of a highly black material opaque to light;
an acquisition sensor configured to detect a fluorescent beam emitted from said plane of the sample; and
movement means configured to move said first rotating disk and second rotating disk in such a way that the resulting excitation beam is created by the passage of said structured light beam through at least one opening resulting from the overlapping of said holes, wherein each opening is resulting from the overlapping of a respective first hole included in the first rotating disk and of a respective second hole included in the second rotating disk,
wherein said movement means is configured to move said first rotating disk and second rotating disk according to a mutual translation motion,
wherein the area of said openings is variable by adjusting the reciprocal position of said first rotating disk and second rotating disk,
wherein said movement means comprises:
a motor configured to be integrally coupled with said first rotating disk, and
motion transmission means configured to kinematically couple said motor with said second rotating disk,
wherein said motion transmission means is configured to perform a translation of said second rotating disk with respect to said first rotating disk,
wherein said motion transmission means is configured to perform a linear sliding displacement of the second rotating disk with respect to the first rotating disk, wherein the rotation axes of each first and second rotating disk remain coincident, through the use of prismatic guides and an axial conical pusher.

2.-5. (canceled)

6. The apparatus according to claim 1, wherein said holes have a polygonal, geometry.

7. The apparatus according to claim 1, wherein said holes have a regular rhomboidal or square geometry.

8. The apparatus according to claim 1, wherein said holes have different dimensions depending on whether they are included on the first or on the second rotating disk and/or on the distance from rotation axis (R of the respective first or second rotating disk.

9. The apparatus according to claim 1, wherein said holes are arranged on said mask according to an Archimedean spiral pattern.

10. The apparatus according to claim 1, wherein said disk group is configured to provide a transmission oil-tight housing interposed between said first and second rotating disk.

11. The apparatus according to claim 6, wherein said holes have a quadrangular geometry.
